(19) United States
(12) Patent Application Publication
(10) Pub. No.: US 2009/0026400 A1
(43) Pub. Date: Jan. 29, 2009

(54) Modular Hose Coupler

(75) Inventor: Maggie Chen, Union City, CA (US)

Correspondence Address: MICHAELSON & ASSOCIATES, P.O. BOX 8489, RED BANK, NJ, 07701-8489, US

(73) Assignee: Maggie Chen, Union City, CA (US)

(21) Appl. No.: 11/884,848

(22) PCT Filed: Mar. 3, 2006
(86) PCT No.: PCT/US2006/007580

§ 371 Date: May 7, 2008

Related U.S. Application Data
(60) Provisional application No. 60/658,386, filed on Mar. 3, 2005.
(60) Provisional application No. 60/711,546, filed on Aug. 26, 2005.
(60) Provisional application No. 60/716,614, filed on Sep. 13, 2005.
(60) Provisional application No. 60/756,742, filed on Jan. 6, 2006.

(51) Int. Cl. F16L 33/00

(52) U.S. Cl. 251/149.1

(57) ABSTRACT

A modular hose coupler for carrying air or other gas is described including in some embodiments a valve (1) designed to reduce air-hammer effects and improve aerodynamic flow. Some embodiments include self-lubrication. Some embodiments include a secure release ring (2) requiring twisting before release, reducing accidental release in debris-laden industrial environments. Other embodiments include sealing structures (01, 02, 03) designed for exclusion of dirt, robust performance and enhanced lifetime.

### BACKGROUND OF THE INVENTION

1. Field of Invention

This invention relates generally to the field of coupling devices and, more particularly, to a modular hose coupler device suitable for coupling hoses or other conduits carrying high pressure air as well as other gases.

2. Description of the Prior Art

There are numerous types, designs and constructions for hose couplers including the following U.S. Pat. Nos. 3,788,598; 3,589,673; 4,157,843; 4,216,982; 4,850,620; 5,123,447; 5,240,023; 5,655,794; 5,788,289; 5,890,748; 5,988,693; 6,206,431; 6,318,763; 6,709,019; and US Patent Application Publication 2003/0047943. While such prior designs typically have advantageous fields of use, there exists a need in the art for a hose coupler that offers improved performance in one or more of the following aspects: ease of connecting and disconnecting, longer service lifetime, improved robustness in service, especially in challenging industrial and/or automotive environments, improved imperviousness to dirt, self-cleaning and/or self-lubricating, as well as other aspects. An improved modular hose coupler meeting one or more of the preceding advantages is an objective of the present invention.

### SUMMARY OF THE INVENTION

Accordingly and advantageously the present invention describes a modular hose coupler for carrying air or other gases, typically under pressure, designed for rapid attachment, improved performance and improved robustness and service lifetime, particularly in industrial or automotive environments typically containing considerable debris.

Some embodiments of the invention use a valve in which holes for passage of air are chosen as large as possible consistent with structural integrity of the valve. Other embodiments include the circumferential placement of holes in the valve such that no two holes are directly facing each other across the central axis of the valve. This configuration avoids air hammer effects and improves valve performance.

Other valve configurations include a tapered tip, typically having a conical, rounded conical or similar shape with the tapered end pointing into the air flow (that is, “upstream”) thereby improving aerodynamic flow around and through the valve.

Other embodiments include a locking ring having structure and location so the hose coupler can be uncoupled, disengaged or released only following an angular twist of the release ring around its central axis. That is, rather than disengagement by a simple axial translation of the release ring, an angular twist followed by an axial translation is required. This helps prevent accidental disengagements of the hose coupler when, for example, the hose is dragged across a debris-laden floor.

Other embodiments include a lubrication chamber that supplies lubricant to the outer surface of the valve, or to the inner surface of the main body, or to both, thereby reducing wear and increasing service lifetime. Advantageously, some embodiments include an opening or other means whereby lubricant can be added to the lubrication chamber when depleted, thereby ensuring adequate lubricant throughout service.

Various sealing structures are employed that increase performance, robustness and service lifetime as described in detail below.

These and other advantages are achieved in accordance with the present invention as described in detail below.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not to scale.

The techniques of the present invention can readily be understood by considering the following detailed description in conjunction with the accompanying drawings in which:

FIG. 1 depicts a typical hose coupler pursuant to some embodiments of the present invention in side view and perspective view: (FIG. 1a) Assembled and disassembled hose coupler. (FIG. 1b) Enlarged side view and perspective view of disassembled hose coupler. (FIG. 1c) enlarged side and perspective view of assembled hose coupler.

FIG. 2 depicts in (FIG. 2a) a typical valve in exploded view along with other components, and (FIG. 2b) axial cross sectional and perspective views of typical valves and an enlarged view in (FIG. 2c), side and end cross-sectional views of other valve embodiments (FIG. 2d and FIG. 2e).

FIG. 3 is a perspective view of the assembled hose coupler depicting the hose coupler both with (FIG. 3a) and without (FIG. 3b) a valve coupler coupled thereto, and disassembled components (FIG. 3c).

FIG. 4 depicts a partial cut-away view of A magnified hose coupler model with the valve coupler in its locked or engaged position (FIG. 4a), and in its unlocked or disengaged position (FIG. 4b).

FIG. 5 is a magnified cut-away view with release ring 2 in its locked position A_{L} (FIG. 5a) and its released, unlocked or disengaged position A_{R} (FIG. 5b).

FIGS. 6a-6c are magnified cut-away views of a typical hose coupler in various stages of disassembly.

FIGS. 7a-7c are magnified, cut-away, perspective views of disassembled hose coupler with valve coupler removed.

FIG. 8 depicts in perspective view (FIG. 8a) a typical tail body, and in magnified view (FIG. 8b).

FIGS. 9a-9c depicts cross-sectional side and end views of typical tail bodies pursuant to some embodiments of the present invention.

FIG. 10 depicts cross-sectional side views of some embodiments of the present hose coupler in its coupled or open position allowing air flow position (FIGS. 10a, 10d, 10f) and uncoupled or closed position blocking air flow (FIGS. 10b, 10c, 10e).

FIG. 11 depicts cross-sectional side and end views of a hose coupler main body pursuant to some embodiments of the present invention.

FIG. 12 depicts cross-sectional side and end views of a hose coupler main body pursuant to some embodiments of the present invention.

FIG. 13 depicts cross-sectional side and end views of a hose coupler main body depicting locking bolt.

FIG. 14 depicts cross-sectional side and end views of a hose coupler main body pursuant to some embodiments of the present invention.

FIG. 15 depicts cross-sectional side view of a hose coupler end cap pursuant to some embodiments of the present invention.

FIG. 16 depicts an exploded cross-sectional side view of some components of a typical hose coupler pursuant to some embodiments of the present invention.

FIG. 17 depicts an exploded cross-sectional side view of some components of a typical hose coupler pursuant to some embodiments of the present invention.

FIG. 18 depicts in cross-sectional side view the assembled components of FIGS. 16 and 17 in their engaged positions.

FIG. 19 depicts in cross-sectional side view the assembled components of FIGS. 16 and 17 in their disengaged positions.

FIG. 20 depicts in cross-sectional side view typical hose coupled including lubrication chamber in the closed position (FIG. 20(A)) and in its open position (FIG. 20(B)).

FIG. 21 depicts cross-sectional side and end views of a hose coupler main body.

FIG. 22 depicts cross-sectional side and end views of a valve.

FIG. 23 depicts cross-sectional side and end views of the main body (FIG. 23a) and the out ring (FIG. 23b) from the hose coupler depicted in FIGS. 10c and 10d.

FIG. 24 depicts in cross-sectional side and end views the main body (FIG. 24a), the front cap (FIG. 24c) and the tail body (FIG. 24d) from the hose coupler depicted in FIGS. 10e and 10f. FIG. 24b depicts in cross-sectional side view the side ring from the hose coupler of FIGS. 10e and 10f.

### DETAILED DESCRIPTION OF THE INVENTION

The present invention relates to hose couplers and, more particularly to a modular hose coupler for carrying air, high pressure air, as well as other gases. Hereinafter all such gases are collectively referred to as “air” for economy of language. Typical couplers pursuant to various embodiments of the present invention are capable of rapidly and securely attaching and detaching to a hose, tube, pipe or other air-carrying conduit (referred to collectively herein as “hose” for economy of language). Typical hose couplers pursuant to various embodiments of the present invention are also capable of rapidly and securely attaching and detaching to a nozzle, air gun, valve, or any other form of air tool, air-powered machine or other equipment requiring the delivery of the air or gas carried by the hose (hereinafter “air tool” for economy of language). The coupler pursuant to some embodiments of the present invention typically forms a superior seal when compared to conventional prior art coupling devices. Other advantages of various embodiments of the present invention include a more robust construction and fewer problems when used in typical industrial environments, self-cleaning capabilities, self-lubricating capabilities, a longer service lifetime, among other advantages that will be apparent to those skilled in the art from the following detailed description.

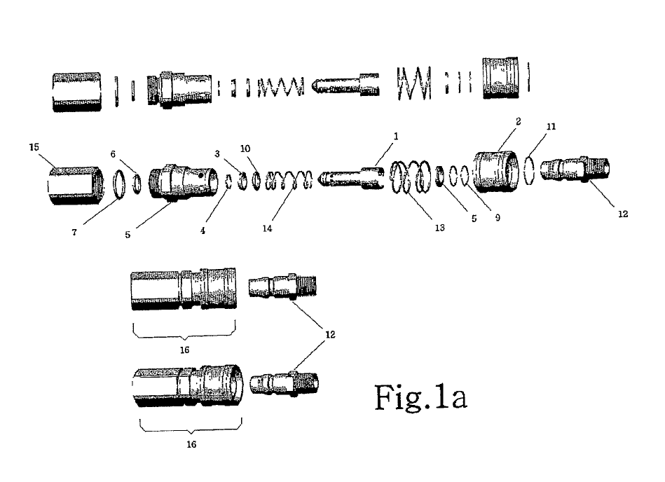

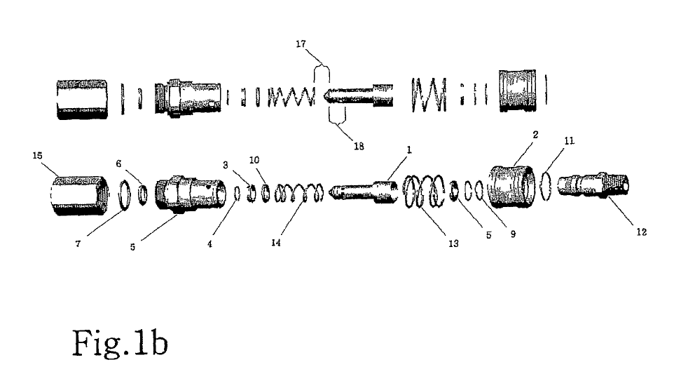

FIGS. 1a, 1b and 1c depict in exploded side views and side-perspective views various components of a typical hose coupler pursuant to some embodiments of the present invention. An assembled coupler is depicted as 16 in FIG. 1a to be connected or mated with valve coupler, 12. FIG. 1c depicts a typical coupling operation in which release ring 2 slides in direction “A” for coupling and uncoupling valve coupler 12.

FIG. 1b indicates valve 1 as having holes therein, 18, for the passage of air or other gas. Valve 1 is depicted in FIG. 1 as having a pointed tip, 17, substantially in the shape of a cone. This shape for the valve tip is advantageous in some embodiments of the present invention, typically helping to facilitate efficient and aerodynamic air flow. However, a blunted or rounded cone tip or other tapered shape, generally aerodynamic and/or elongate shapes of valve tip can also be advantageously employed in some embodiments of the present invention. Examples of some alternative shapes are given in embodiments of the present invention described elsewhere herein. As depicted herein, the tapered end of the valve body is directed upstream, towards the direction from which the air flow arrives, in order to provide advantageous aerodynamic effects.

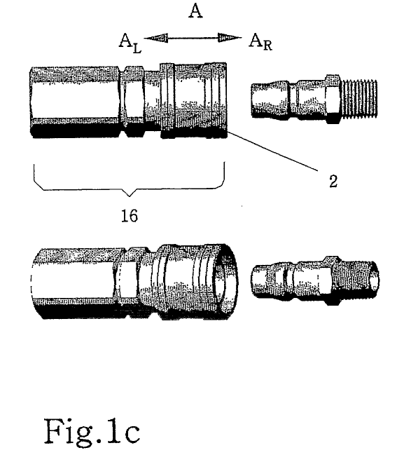

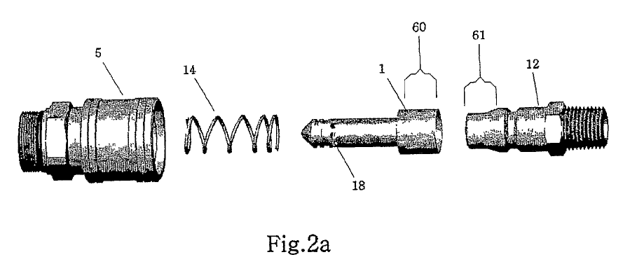

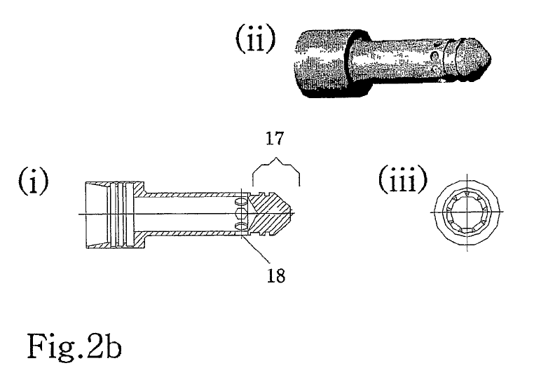

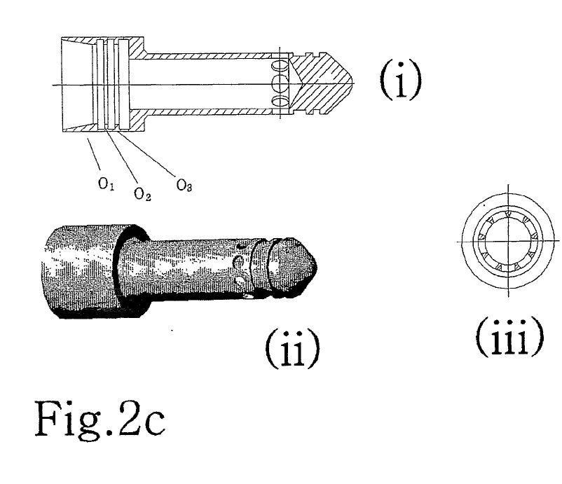

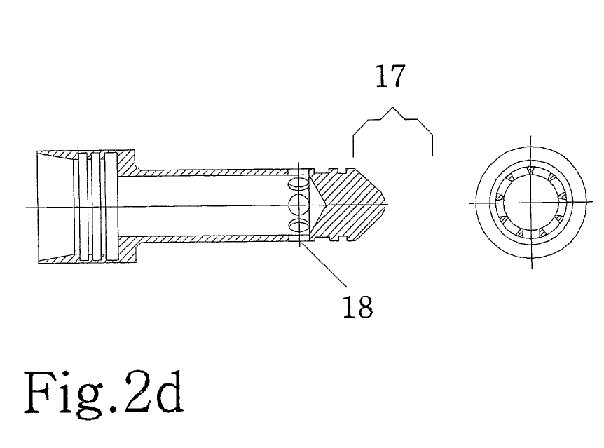

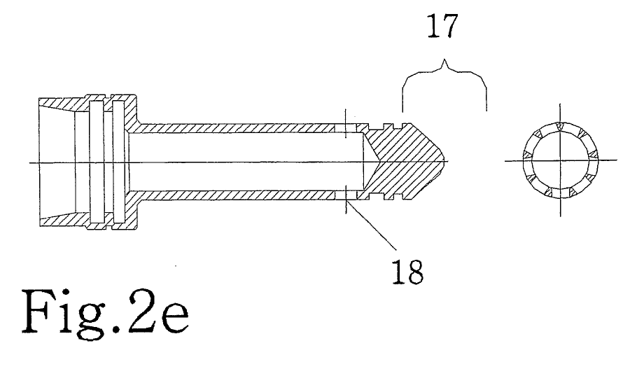

Further details of the assembly and structure of some embodiments of valve 1 are given in FIG. 2. FIG. 2a depicts an exploded view of valve 1, main body 5, valve spring 14, valve coupler 12 and air holes 18. Further details of some embodiments of valve 1 are given in axial cross section view (FIGS. 2b(i) and 2c(i), perspective view (FIGS. 2b(ii) and 2c(ii)), and end view (FIGS. 2b(iii) and 2c(iii)). Multiple rows of holes as depicted in FIG. 1, as well as a single row of holes as depicted in FIG. 2 are included within the scope of the present invention. However, it is found to be advantageous in some embodiments of the present invention for the holes 18 to be arranged for effective aerodynamic flow of air through the valve. Typically, a row of holes equally spaced around the circumference of valve 1 is advantageous with an odd number of holes leading to more effective air flow and more effective valve performance. Five (5), seven (7) or nine (9) holes distributed substantially uniformly around the circumference of the valve are typically found to give advantageous performance in connection with some embodiments of the present invention. Holes located radially symmetrically, that is directly facing one another across the central axis of valve 1, are found to give generally less desirable performance. Typically, an air hammer effect can arise when holes face each other directly across the central axis of the valve, tending to reduce performance of the valve. In addition, holes with larger diameters consistent with the geometry and the structural integrity of the valve are found to be generally advantageous.

FIGS. 2d and 2e depict some other embodiments of valve 1 with various configurations of holes, 18, valve tip 17, valve body 69 and valve base 60 at the end of the valve body opposite the tip.

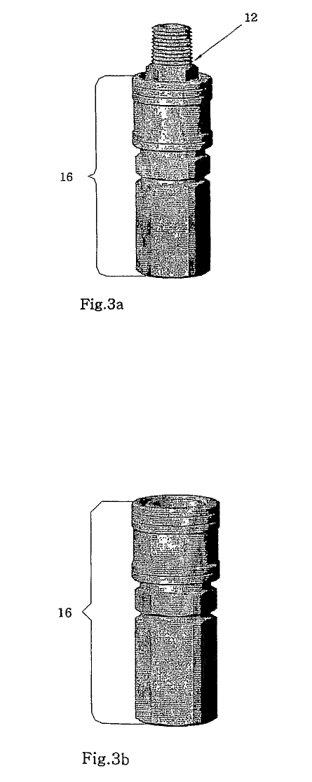

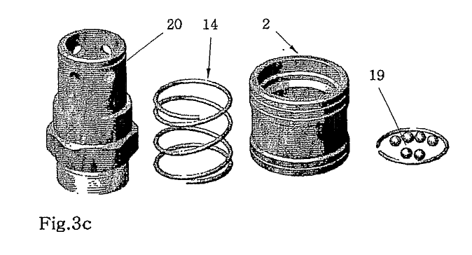

FIG. 3 depicts the assembled coupler 16 with (FIG. 3a) and without (FIG. 3b) valve coupler 12 being inserted. Components included in the assembled coupler include those depicted in FIG. 3c. In the assembled coupler, ball bearings 19 reside in bearing holes 20, surrounded by valve spring 14 and held in place by release ring 2.

In order to depict components more clearly as typically arise in some embodiments of the present invention, a model system was constructed to larger scale. That is, a hose coupler was constructed approximately 10 times magnified over typically hose couples in practical use. This expanded model allowed partial cut-away views to be depicted and these are shown herein.

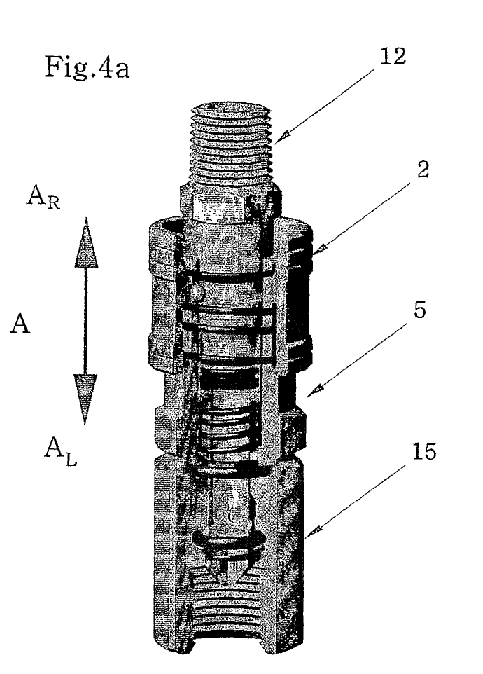

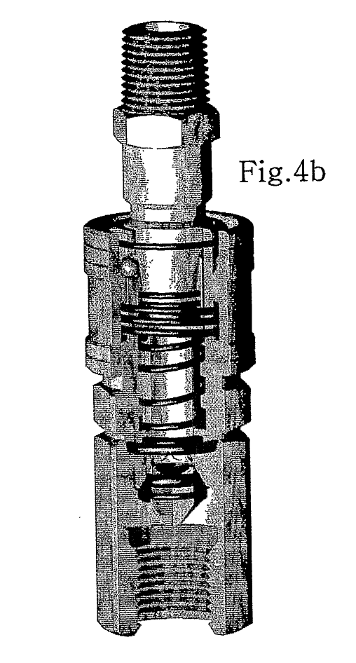

FIG. 4 depicts a partial cut-away view of the magnified model with the valve coupler in its locked position (FIG. 4a), and in its disengaged position (FIG. 4b). Moving release ring 2 in the direction of A causes disengagement of valve coupler 12.

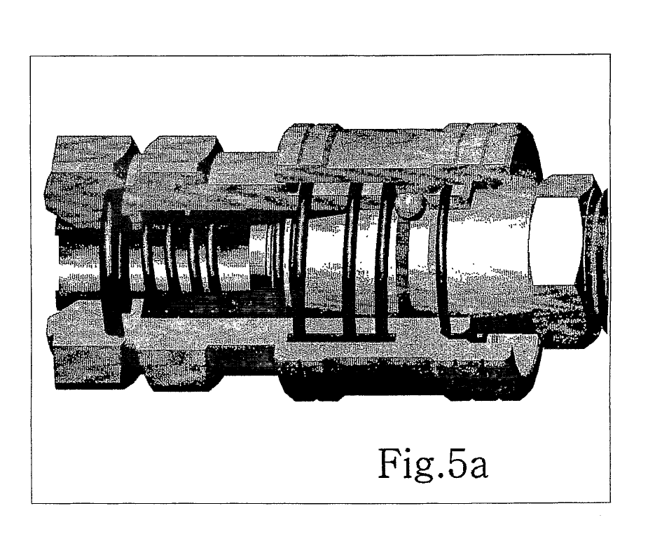

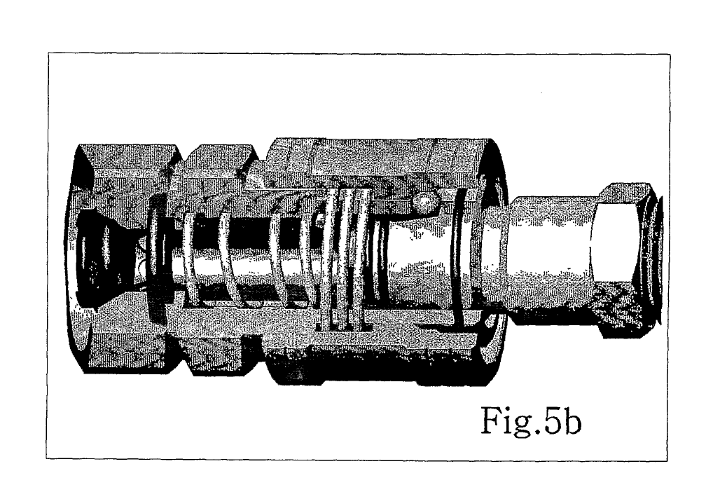

FIG. 5a is a close-up view of the cut-away substantially as in FIG. 4a with valve coupler 12 in its locked position A_{L} and the direction of traverse of release ring 2 indicated by A. FIG. 5b has the release ring 2 moved in the released direction A_{R}, causing valve coupler 12 to disengage. The bearings over which release ring 2 moves are visible in FIG. 5b.

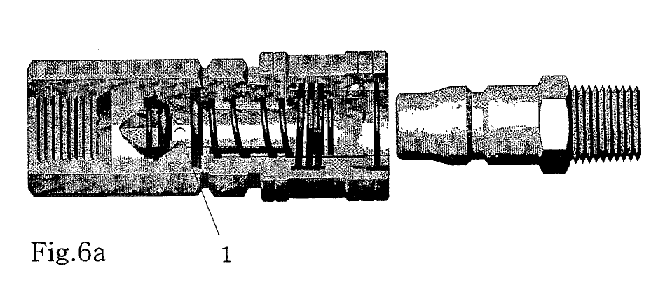

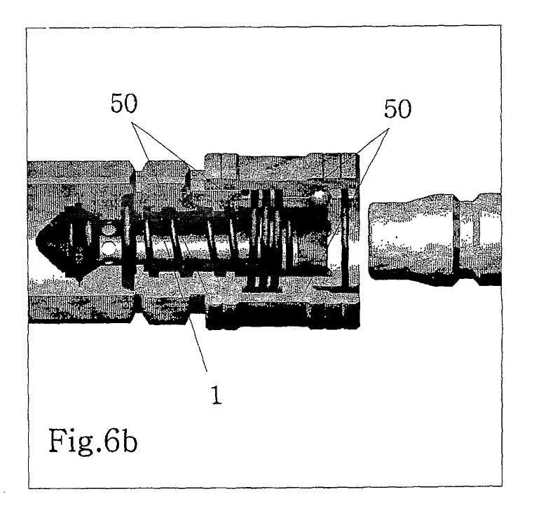

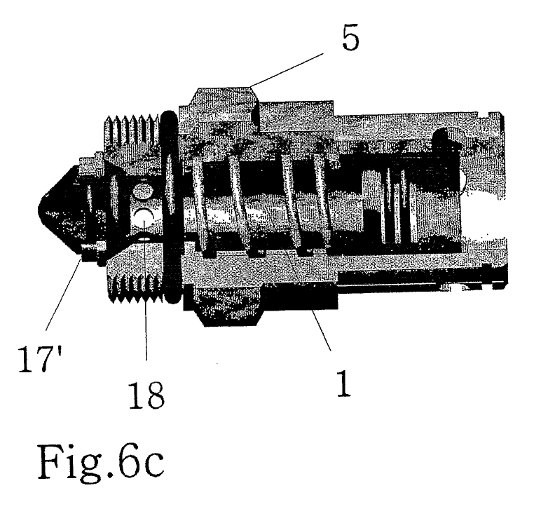

FIG. 6 depicts the magnified cut-away hose coupler model in various stages of disassembly. Valve 1 depicted in FIG. 6 (especially visible in FIG. 6c) has a flat portion 17′ in place of the conical shaped face in FIG. 1 and FIG. 2. While the conical valve surface 17 is advantageous in many applications, the present invention is not limited to a conical valve face and a flat face (as in FIG. 6c) as well as other shapes are included within the scope of the present invention.

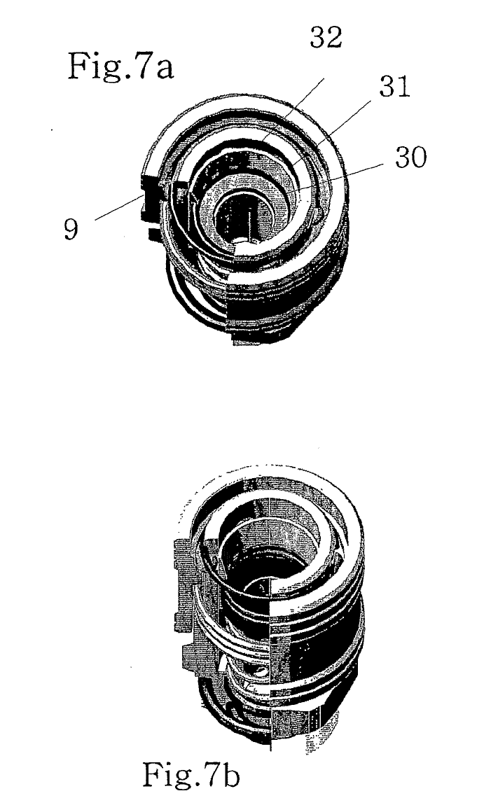

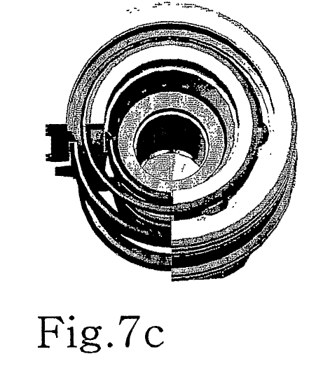

Another advantageous feature of some embodiments of the present invention is improved sealing and self-cleaning. The present hose coupler is typically manufactured having tight tolerances between the inner surface of ring release ring 2 and the outer surface of valve 1, depicted as 51 in FIG. 7a. Regions of close contact are depicted as 50 in FIG. 6b. It is envisioned that the couplers of the present invention will often be used in industrial environments in which dirt is prone to collect in region 51. If not removed, such dirt can increase wear and shorten the useful service life of the coupler. Tight tolerances help prevent accumulation of such dirt in regions 51. In addition, another advantage of the self-cleaning feature of some embodiments of the present invention is to reduce or prevent jamming between the release ring 2 and the main body 5. By keeping these spaces between release ring 2 and valve 1 as small as is feasible, improved sealing results, as well as expulsion of dirt, grime etc. as the ring 2 slides (horizontally in FIG. 6b) to cause valve coupler 12 to engage and disengage.

Other advantages of the present invention include improved sealing capabilities. That is, the present hose coupler is typically less prone to leakage. Among the reasons for this robust performance is the sealing used in connection with some embodiments of the present coupler. It is found to be advantageous in some embodiments of the present invention to use triple O-ring seals between the inner surface of valve 1 and the outer surface of valve coupler 12. These three O-rings are depicted as O₁, O₂ and O₃ in FIG. 2c. These O-rings on the interior of valve 1 (in region 60 of FIG. 2a) seal tightly against the outer surface of the valve coupler, depicted as 61 in FIG. 2a. This triple sealing provides enhanced sealing capabilities and back-up sealing as one or more O-rings may become worn, damaged or brittle during extended use. This enhanced sealing can thus extend the useful service lifetime of the present coupler.

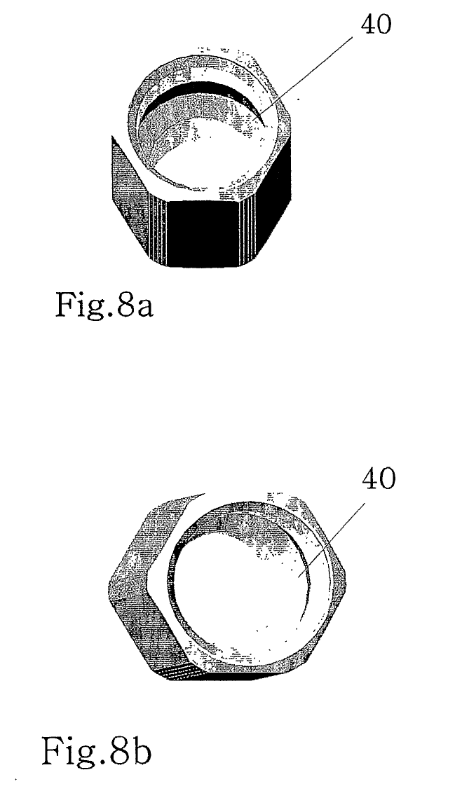

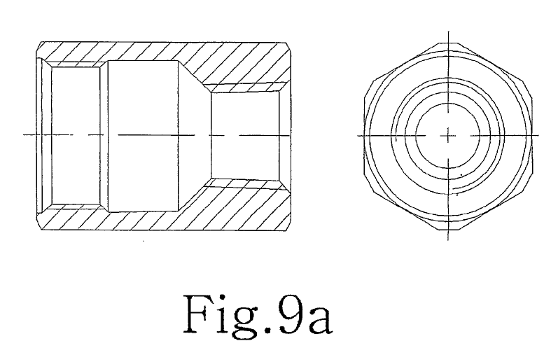

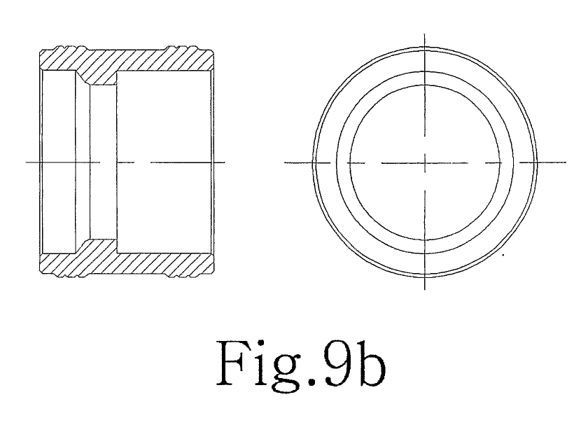

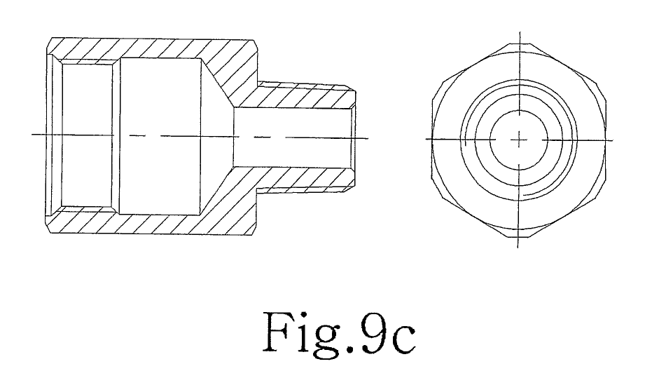

FIG. 8 depicts in perspective view, tail body 15 (as in FIG. 1), including ledge 40 found to be advantageous in some embodiments of the present invention. FIG. 9 are cross-sectional side and end depictions of various embodiments of the tail body (FIGS. 9a, 9b, 9c respectively).

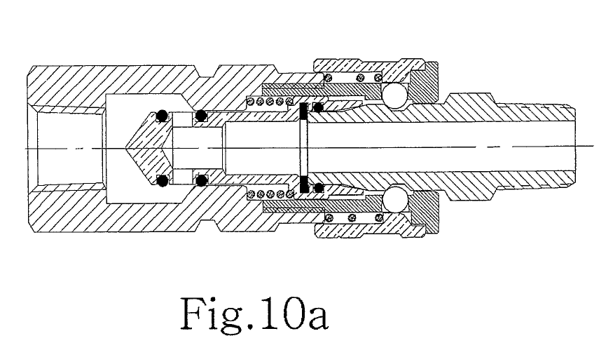

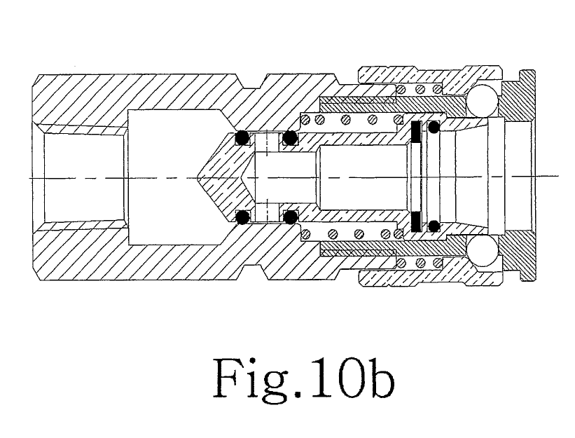

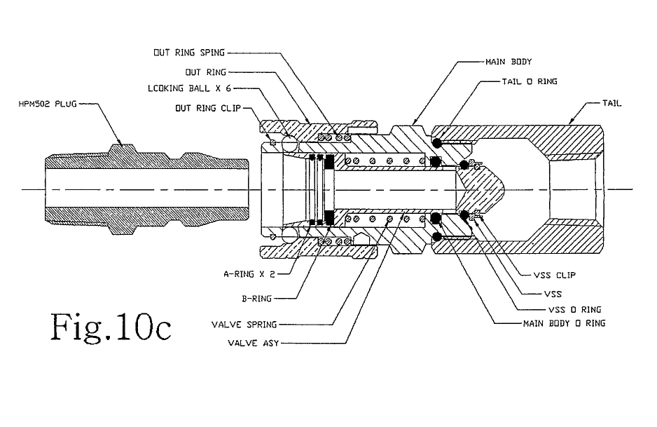

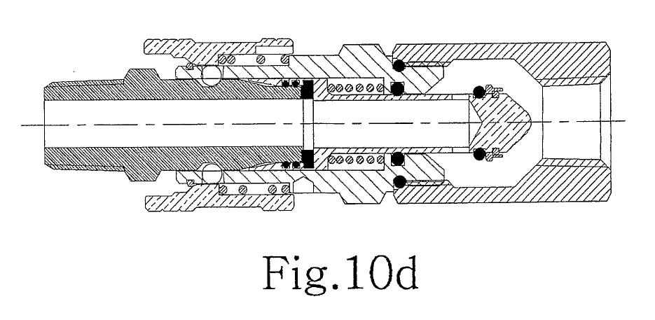

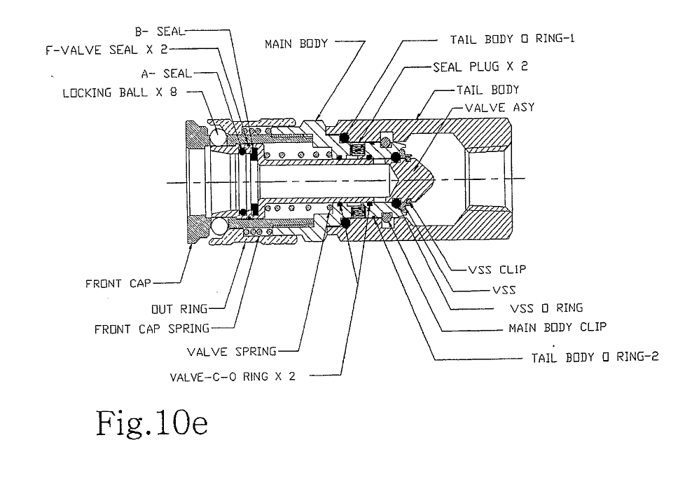

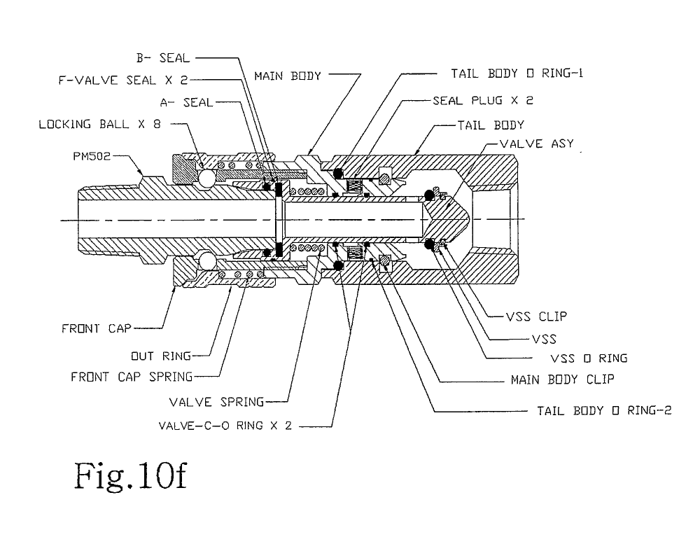

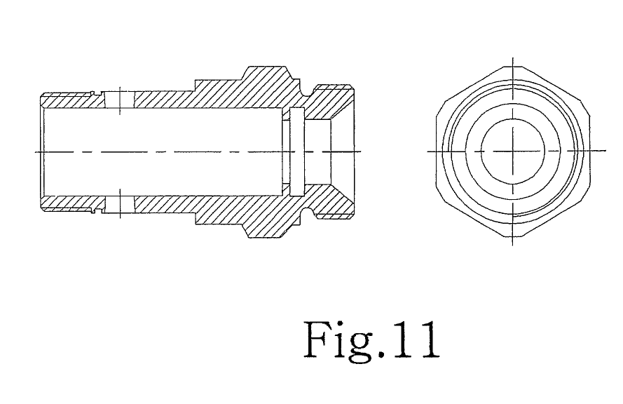

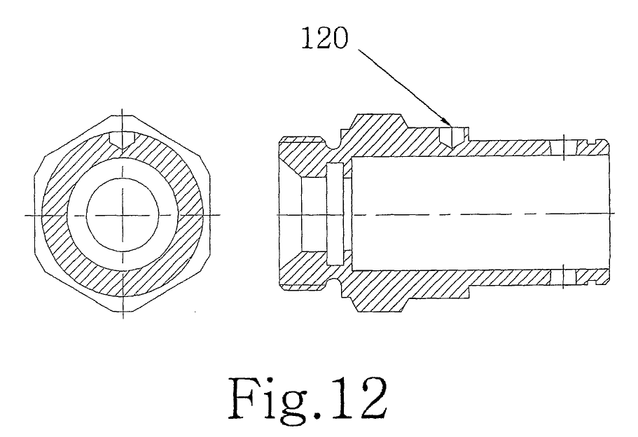

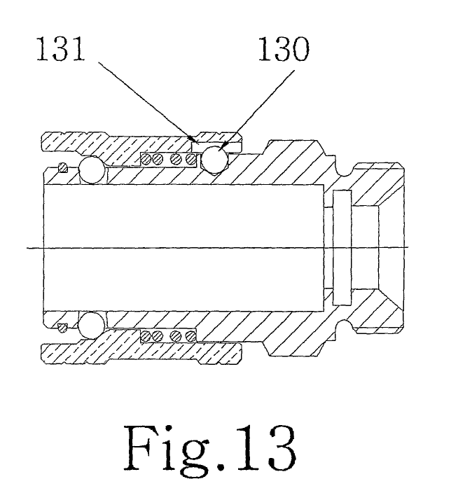

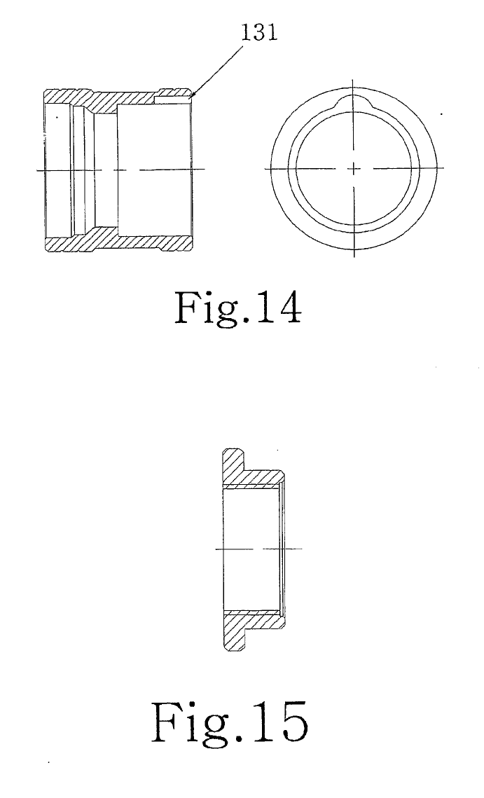

Other embodiments of the present hose coupler, and some of its components, are depicted in FIGS. 10-15. For example, in some environments a hose with a hose coupler and air tool attached will commonly be dragged across a workshop or garage floor. During this transit, the release ring may come into contact with objects such as debris, tools, surface irregularities in the floor, among other objects or structures lying about the floor, causing the release ring accidentally to disconnect from the plug. Such contact with the release ring in cooperation with the motion of the hose can lead to inadvertent and undesired release of the hose coupler. FIG. 13 depicts in cutaway cross-sectional view the inclusion of an additional locking bolt, 130 and chamber 131 (also in FIG. 14). A hole for this bolt is also inserted into the main body of the coupler, 120 in FIG. 12. Although a single bolt is depicted in these figures, and is typically sufficient for preventing inadvertent release, more than one locking bolt can be used in other embodiments of the present invention.

The location and purpose of this locking bolt is to reduce or avoid inadvertent release of the hose coupler. When valve coupler 12 is inserted into coupler 16, locking occurs. However, in the presence of the locking bolt 130, the release ring is given a small turn following locking of the valve coupler. Thus, any attempted axial motion of the release ring along or parallel to the central axis of the hose coupler will be resisted and will not occur, thereby preventing release of the coupler. When it is desired to release the valve coupler 12, the release ring is turned circumferentially to a position so as to disengage the locking bolt, thereby allowing axial motion and release of the coupler.

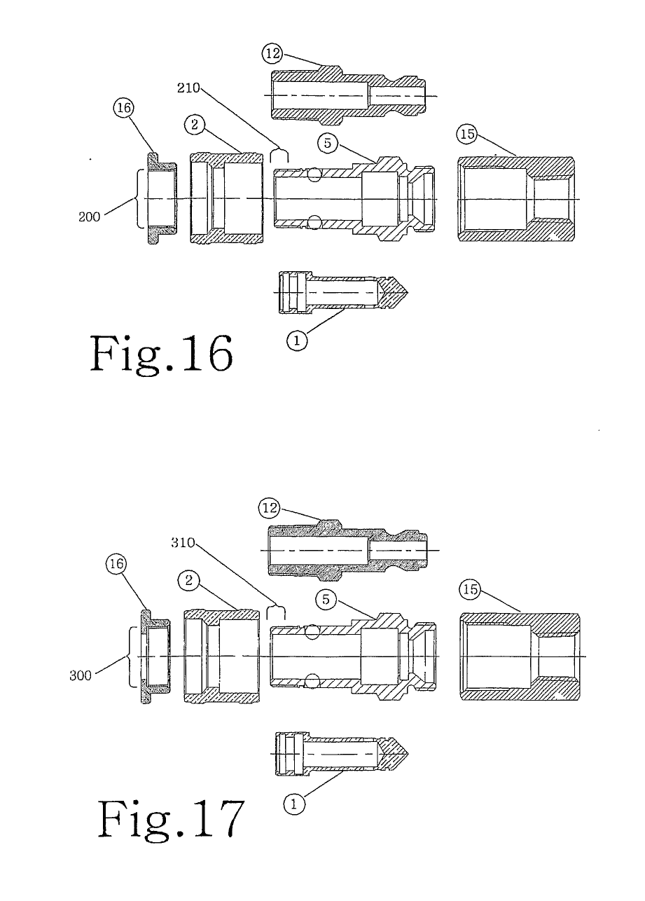

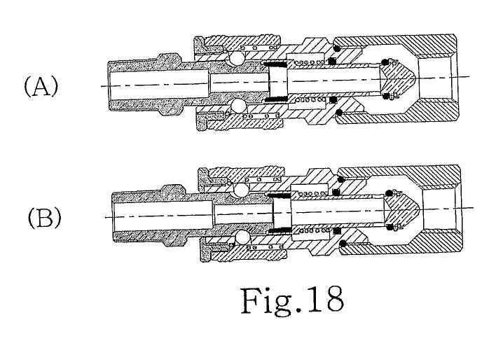

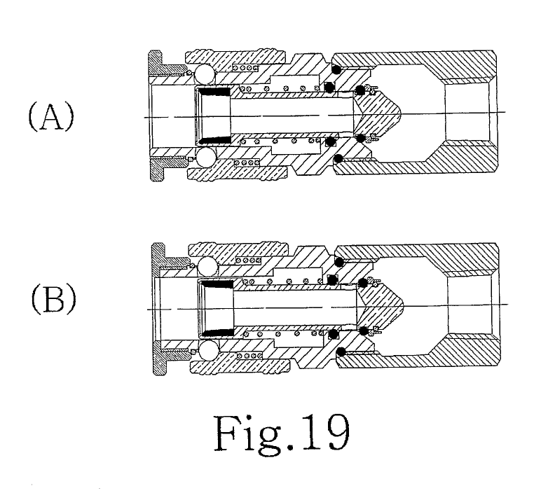

Other embodiments of the present invention include the addition of another coupling cap, (16 in FIG. 16) that attaches to main body 2. Two embodiments of coupling cap 16 are depicted in FIG. 16 and FIG. 17, indicated as 200 and 300 respectively. Version 200 includes an opening completely through the longitudinal axis of ring 16. This longer opening allows for screw threads to be employed on the interior of 16 that have a wider pitch. This allows for increased strength, less susceptibility to vibrations or shocks, among other advantages. Version 300 in FIG. 17 has less room available for threads. The use of these two versions of the release coupling ring 16 in a hose coupler are depicted in the engaged position in FIG. 18 and in the disengaged position in depicted in FIG. 19. The wider-thread version (200) depicted in FIG. 18(A) and FIG. 19(A), and the narrower-thread version depicted in FIG. 18(B) and FIG. 19(B).

In addition, the length of the main body, 5, can have slightly different lengths (typically about 1-2 mm) in various embodiments of the present invention, as depicted in FIG. 16 (210) and FIG. 17 (310).

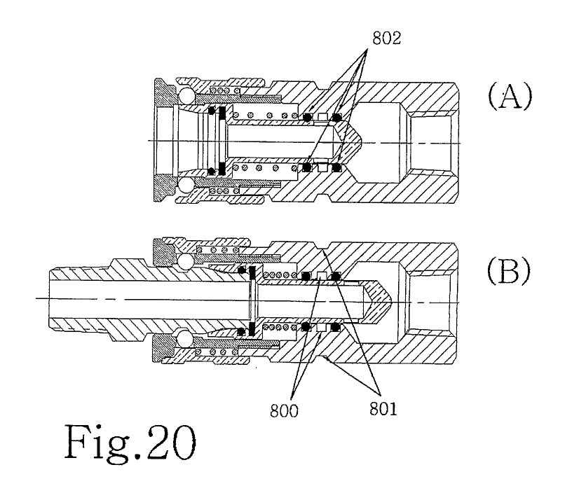

Other embodiments of the hose coupler can include self-lubrication. A typical embodiment is depicted in cross-section in FIG. 20 with the hose coupler in its closed or engaged position (blocking the passage of air) in FIG. 20(A), and in its open or disengaged position (allowing air to pass) in FIG. 20(B). These embodiments include a lubrication chamber 800, depicted in FIG. 20 as circumferentially surrounding the valve body. A single circumferential lubrication chamber is depicted in FIG. 20 but this is not an essential limitation of the present invention as one or more chambers can be employed to give the self-lubricating feature. Furthermore, a lubrication chamber surrounding the valve body circumferentially as depicted in FIG. 20 is advantageous in providing reasonably uniform lubrication from a single reservoir of lubricant, but non-circumferential and/or a plurality of lubrication chambers can be employed within the scope of the present invention.

FIG. 20 also depicts a groove 801 surrounding the coupler substantially at the position of the lubrication chamber 800. The groove 801 can extend in depth all the way to the surface of lubrication chamber 800 (or equivalently, the lubrication chamber can extend to the groove 801). Other embodiments of the present invention include an open channel connecting groove 801 and chamber 800 (typically sealed by a screw or other sealing means). This channel allows the screw or other seal to be opened and lubricant to be refilled into lubrication chamber 800 whenever necessary.

Also depicted in FIG. 20 are additional sealing rings 802 surrounding the lubrication chamber. These optional sealing rings 802 provide additional sealing between the lubrication chamber 800 and the external environment, thereby increasing the effectiveness and lifetime of the lubricant stored in 800, hindering the escape of lubricant from the region between the sealing rings.

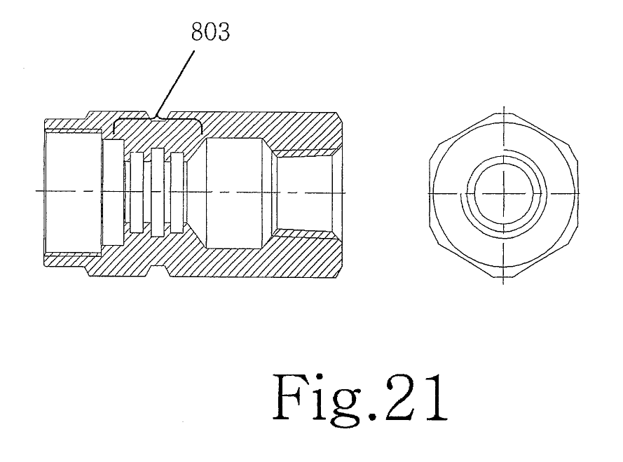

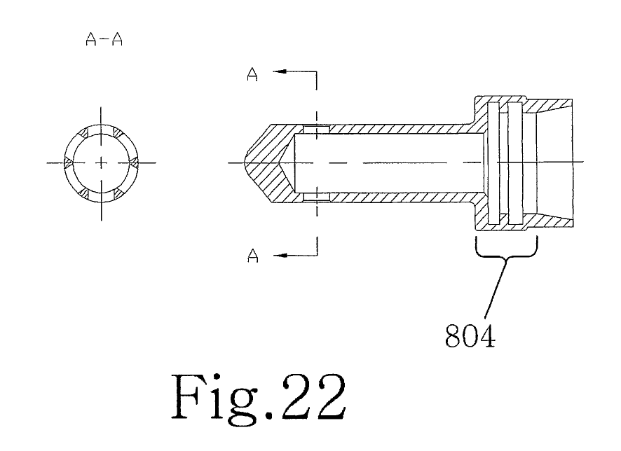

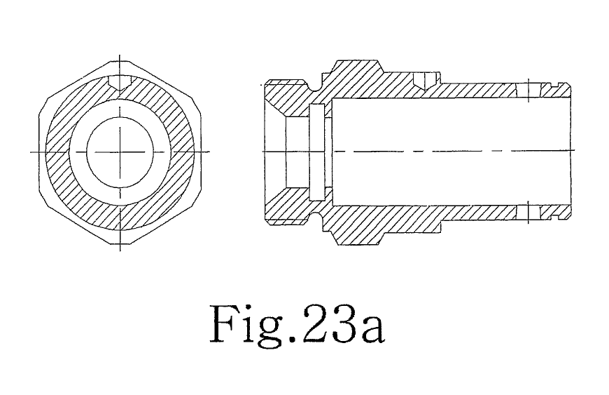

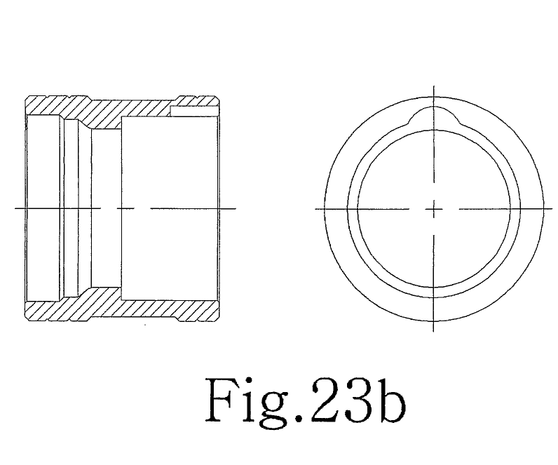

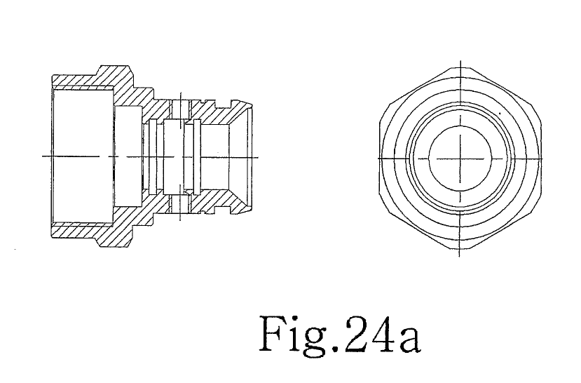

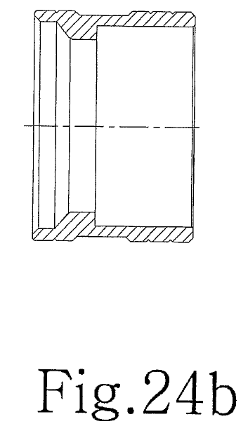

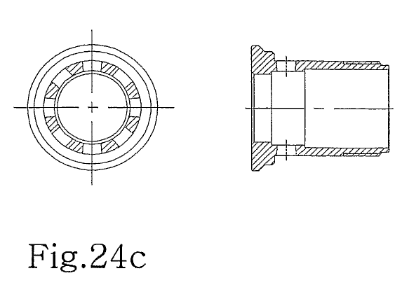

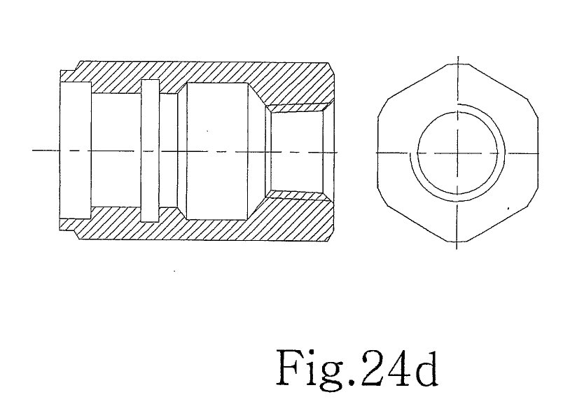

We also note that the number of sealing rings is optional in various positions in the present hose coupler. FIGS. 21 and 22 depict three rings (803) and two rings (804) respectively. A smaller number of larger, stronger rings tend to be more robust in service, but more rings tend to give better sealing properties when functioning properly. In essence, fewer number of rings tend to increase the durability of the assembly while a greater number of rings tend to increase its safety.

Additional embodiments of the present invention can be described by a comparison of one coupler embodiment in its open position allowing the passage of air (FIG. 10a) and closed position, blocking the passage of air (FIG. 10b). Sealing ring 85 is seen in this embodiment to make contact with and slide over the inner wall of the main body which, after many repetitions of opening and closing, can lead to wear and a defective seal. Another embodiment is depicted in FIG. 10d (open) and FIG. 10f (closed) with the addition of a valve seal support 87, valve seal support sealing (or “O”) ring 86 and valve seal support clip 89. In addition the inner surface of the main body is tapered such that sealing ring 86 makes intimate contact with the surface to stop air flow but the sealing ring does not slide over the surface, as depicted in the valve closed position in FIG. 10e. This reduces wear on ring 86, increasing its service lifetime.

Additional features that may be made components of the present hose coupler pursuant to some embodiments of the present invention include additional sealing rings depicted as 90 in FIG. 10e. Should small amounts of dirt and/or dust collect in spring chamber 89, increased wear on the spring is the likely result, and thus premature failure. The additional sealing rings 90 serve to exclude such dirt and thereby increase the lifetime of the spring. Furthermore, by providing a substantially airtight seal, sealing rings 90 help trap air in spring chamber 89, thereby adding the hydraulic effect of an air-spring to the mechanical effect of the mechanical spring. Thus, improved performance and increased service lifetime is the result.

Although various embodiments which incorporate the teachings of the present invention have been shown and described in detail herein, those skilled in the art can readily devise many other varied embodiments that still incorporate these teachings.

What is claimed is:

1. A valve for a hose coupler comprising a substantially cylindrical valve body having at least one row of holes circumferentially located around said valve body wherein said holes have locations on said valve body such that no two of said holes are diametrically aligned through the center axis of said valve body.

2. A valve as in claim 1 wherein said valve body has a tapered shape at one end of said valve body.

3. A valve as in claim 1 further comprising a substantially cylindrical valve base substantially coaxial with said valve body wherein said valve base further comprises a plurality of circumferential grooves suitable for the insertion of base sealing rings, thereby causing tight sealing between said valve base and the inner surface of the main body of said hose coupler.

4. A valve body as in claim 3 further comprising one or more tip sealing rings at the tip end of said valve body opposite said valve base.

5. A hose coupler comprising:
a) a valve comprising a substantially cylindrical valve body having air holes therein, and a substantially cylindrical valve base substantially coaxial with said valve body; and,
b) a substantially cylindrical main body surrounding said valve and substantially coaxial therewith, wherein said valve is capable of sliding substantially freely along the central axis of said main body and engaged by a valve spring; and,
c) a substantially cylindrical release ring substantially coaxial with said main body and capable of sliding along the central axis of said main body to engage and disengage a valve coupler; and,
d) wherein said valve body has at least one row of holes circumferentially located around said valve body wherein said holes have locations on said valve body such that no two of said holes are diametrically aligned through the center axis of said valve body.

6. A hose coupler comprising:
a) a valve comprising a substantially cylindrical valve body having air holes therein, and a substantially cylindrical valve base substantially coaxial with said valve body; and,
b) a substantially cylindrical main body surrounding said valve and substantially coaxial therewith, wherein said valve is capable of sliding substantially freely along the central axis of said main body and engaged by a valve spring; and,
c) a substantially cylindrical release ring substantially coaxial with said main body and capable of sliding along the central axis of said main body to engage and disengage a valve coupler; and,
d) further comprising at least one locking bolt such that said release ring requires and angular movement about said central axis to enable disengagement of said valve coupler.

7. A hose coupler comprising:
a) a valve comprising a substantially cylindrical valve body having air holes therein, and a substantially cylindrical valve base substantially coaxial with said valve body; and,
b) a substantially cylindrical main body surrounding said valve and substantially coaxial therewith, wherein said valve is capable of sliding substantially freely along the central axis of said main body and engaged by a valve spring; and,
c) a substantially cylindrical release ring substantially coaxial with said main body and capable of sliding along the central axis of said main body to engage and disengage a valve coupler; and,
d) further comprising at least one lubrication chamber circumferentially surrounding said valve body so as to dispense lubricant onto the outer surface of said valve body.

8. A hose coupler comprising:
a) a valve as in claim 4; and,
b) a substantially cylindrical main body surrounding said valve and substantially coaxial therewith, wherein said valve is capable of sliding substantially freely along the central axis of said main body and engaged by a valve spring; and,
c) wherein at least one of said tip sealing rings forms a seal with the inner surface of said main body when said valve is in its closed position without sliding over said inner surface of said main body.
